(19) United States
(12) Patent Application Publication
(10) Pub. No.: US 2013/0024790 A1
(43) Pub. Date: Jan. 24, 2013

(54) LINKING PRODUCT CONFIGURATION TOOL WITH NETWORKING SITES

(71) Applicant: KARLHEINZ AGSTEINER, Wiesloch (DE)

(72) Inventor: KARLHEINZ AGSTEINER, Wiesloch (DE)

(21) Appl. No.: 13/184,569

(22) Filed: Jul. 18, 2011

(51) Int. Cl. G06F 3/048

(52) U.S. Cl. 715/760

(57) ABSTRACT

Various embodiments of systems and methods for linking product configuration tool with networking site(s) are described herein. In one aspect, the method includes receiving a data to identify the product configuration tool, selecting an active tag on the networking site, based upon the active tag, sending a command to the product configuration tool, in response to the command, receiving one or more resultant data, and rendering a context menu including the one or more resultant data on the networking site. The product configuration tool(s) may be accessed while writing or reading a blog on the networking site. Further, a user can easily compose the blog, e.g., by selecting a resultant data from the context menu. Additionally, the context menu provides context(s) related to the active tag. Moreover, configuration UIs for maintaining knowledge base and/or visualizing a configuration of the product configuration tool can be accessed from the networking site(s).

### FIELD

The technical field relates generally to a product configuration tool, and more particularly to linking the product configuration tool with networking site(s).

### BACKGROUND

Product configuration tool is a tool for configuring a complex product or machinery that comes in several variations (i.e., configurable product). For example, cars, pumps, drilling machines, printing machines, bottling and packaging machines, etc., are configurable products that include several variations. Typically, one or more features or parts of the configurable product have several variations. For example, the following features of the car (configurable product) have several variations as listed below:

| Feature/Part of Car | Possible Options |
|---|---|
| Body color | Red, blue, green, and silver |
| Engine Type | Diesel, petrol, and hybrid |
| Model | Vxi, Lxi, and Lv |

The car may be configured based upon requirements of an end user (customer). Usually, a sales representative configures the configurable product based upon the requirement of the end user. For example, if the end user requires a blue color car with a petrol engine then the sales representative configures the features (i.e., the body color and engine type) of the car accordingly.

The product configuration tool is used to configure the configurable product (e.g., car). There may be product configuration tool for configuring each specific configurable product. For example, there may be a BMW® configuration tool for configuring BMW® cars, a Dell® PC configuration tool for configuring Dell® PCs, etc. Typically, each product configuration tool includes various User Interface (UI) components for selecting the options related to configurable features/ parts of the specific product. Once the product is configured, the sales representative may create sales order pertaining to the end user.

Typically, it is the sales representative who deals with the product configuration tool regularly (e.g., for creating sales orders, etc). The sales representative may need to communicate or share sales related information, sales related developments, or ideas related to a market trend of the product, etc., to their colleague or department. For example, the sales representative might need to communicate that “xy model is not selling well and it might be required to slow down the production and/or reduce price,” etc. The sales representative may also need to interact with designers (e.g., people who create different options for the configurable parts/ features in the user interface of the product configuration tool) to analyze technical features related to the product and/or to reply to queries related to technical issues, etc. Therefore, the sales representative interacts with the designers or other sales representative(s). Usually, the sales representative communicates through networking sites (e.g., social or personal). Now-a-days, social networking sites, e.g., Twitter®, Face book®, Delicious®, etc., are commonly used by the sales representatives to discuss various technical and sales related issues.

Usually, while interacting (e.g., blogging) the sales representative use uncommon technical terms (e.g., codes or short form) related to various features of the configurable product. Particularly, experienced sales representatives are familiar and comfortable with these terms and they use these terms in their regular conversation. For example, the sales representative might prefer to use the term “TF_{—}330” instead of “Transformer 330MW” in their regular conversation. Therefore, the sales representative may prefer blogging or twittering “TF_{—}330 model is selling very well” instead of “Transformer 330MW model is selling very well.”

However, it might be inconvenient or difficult to write the uncommon technical terms that are difficult and/or lengthy. For example, it might be inconvenient and difficult to write “DOX_{—}098_{—}56_todlex_khtres.pbelts” while blogging. Also, the lengthy and difficult terms are error prone and there is a high probability of making mistakes or errors while writing these terms. Moreover, it might be difficult for some sales representatives (e.g., newly joined sales representative) to comprehend the uncommon technical terms posted on the blog. Again, it may be inefficient and time consuming to ask the blogger to clarify the terms. Additionally, it may be inconvenient and time consuming to contact the designer to understand the technical details related to the configurable product.

### SUMMARY OF THE INVENTION

Various embodiments of systems and methods for linking a product configuration tool with networking site(s) are described herein. In one aspect, a method includes selecting an active tag on a networking site, based upon the active tag, sending a command to the product configuration tool, in response to the command, receiving one or more resultant data related to the active tag, and rendering a context menu including the one or more resultant data on the networking site. The product configuration tool may be accessed while writing or reading a blog on the networking site. Further, the context menu may provide context(s) related to the active tag (term) used in the blog. Additionally, the blog can be easily composed, e.g., by selecting a resultant data (e.g., completion option) from the context menu. Moreover, configuration UIs for maintaining knowledge base and/or visualizing a configuration of the product configuration tool can be accessed from the networking site while composing blog or reading posted blog.

These and other benefits and features of embodiments of the invention will be apparent upon consideration of the following detailed description of preferred embodiments thereof, presented in connection with the following drawings.

### BRIEF DESCRIPTION OF THE DRAWINGS

The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system including a link module for linking a product configuration tool with a networking site, according to an embodiment of the invention.

FIG. 2 is a block diagram of the product configuration tool including a product configuration engine in communication with the link module, according to an embodiment of the invention.

FIGS. 3A-3E are an exemplary screen display of various context menus generated while composing a blog (message) on the networking site, according to an embodiment of the invention.

FIGS. 4A-4C are an exemplary screen display of various context menus generated while reading a posted blog on the networking site, according to an embodiment of the invention.

FIG. 5 is an exemplary screen display of a configuration tool User Interface (UI) generated while interacting with data provided within one of the context menus, according to an embodiment of the invention.

FIG. 6 is a flow chart illustrating the steps performed to link the product configuration tool with the networking site, according to various embodiments of the invention.

FIGS. 7A-7B is a flow chart illustrating the steps performed to generate various context menus while writing and/or reading message on the networking site, according to an embodiment of the invention.

FIG. 8 is a block diagram of an exemplary computer system, according to an embodiment of the invention.

### DETAILED DESCRIPTION

Embodiments of techniques for linking a product configuration tool with networking site(s) are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

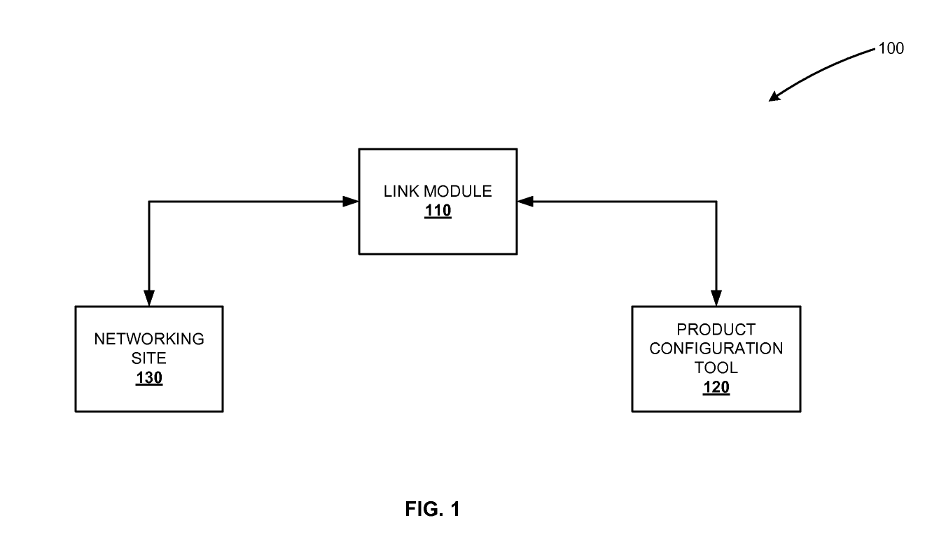

FIG. 1 illustrates one embodiment of a system 100 including a link module 110 for linking a product configuration tool 120 with a networking site 130. A user (e.g., a salesperson, a designer, etc) enters a data (e.g., a Uniform Resource Locator (URL) or the address/ link, etc) related to the product configuration tool 120 into the link module 110. Once the data is entered, the link module 110 recognizes the product configuration tool 120. After recognition, the link module 110 establishes link between the product configuration tool 120 and the networking site 130. Typically, the link module 110 selects an active tag on the networking site 130. Based upon the active tag, the link module 110 sends a command to the product configuration tool 120. In response to the command, the product configuration tool 120 sends one or more resultant data related to the active tag. The link module 110 receives the one or more resultant data and displays a context menu including the one or more resultant data on the networking site 130.

The networking site 130 may be used by the users for communication or exchanging information. For example, the networking site 130 may be used by the salespersons (users) for communicating or exchanging sales related information with each other. The networking site 130 may be a social networking site (e.g., Twitter®, Face book®, Delicious®, etc), personal networking site, or an official networking site (e.g., a networking site of a company where the user works in). Essentially, the user writes or reads blogs (messages) on the networking site 130. The messages may comprise one or more tags.

The tag is a special term within the message that is prefixed by an identifier. The identifier comprises at least one of alphanumeric characters and symbols. For example, the identifier may be ‘#’, PIK, #CFG, or #2, etc. The tag may be selected or identified by identifying the identifier prefixed to the tag. For example, if the identifier is # and the message reads “#color_red of XXX4 is not selling well” then it may be identified that “color_red” is the tag as it is prefixed by the identifier #.

The tag may be selected by the link module 110. The tag may be the active tag or an inactive tag. The active tag may be the tag in interaction with the user. The interaction may be by a mouse movement, a keyboard activity, a joystick movement, or combinations thereof For example, the active tag may be the tag selected by the user or the tag under construction. The active tag may be selected by the link module 110.

The link module 110 may be downloaded or installed using the networking site 130. In one embodiment, the link module 110 may be implemented as a plug-in on the computer with that the user accesses the networking site 130. In another embodiment, the user may download the link module 110 on a web browser of the networking site 130. Once downloaded, the link module 110 is activated all the time. In one embodiment, the user may trigger an icon (not shown) to activate the link module 110. The link module 110 may be configured by the user. Typically, the user enters the data (e.g., the URL or the address/ link, etc) related to the product configuration tool 120 into the link module 110. Once the data is entered, the link module 110 identifies the product configuration tool 120. After identification, the link module 110 can send command to the product configuration tool 120. Typically, the link module 110 selects the active tag on the networking site 130 and sends command to the product configuration tool 120.

In one embodiment, the command includes the active tag. In another embodiment, the command includes a data related to the active tag. The command is received by the product configuration tool 120. Based upon the command, the product configuration tool 120 sends response to the link module 110. Typically, the product configuration tool 120 searches the one or more resultant data in a list-of-resultant-data (not shown) to send response to the link module 110. In one embodiment, the list-of-resultant-data may be a special data structure (e.g., a tree structure) configured to perform an efficient or expedient search.

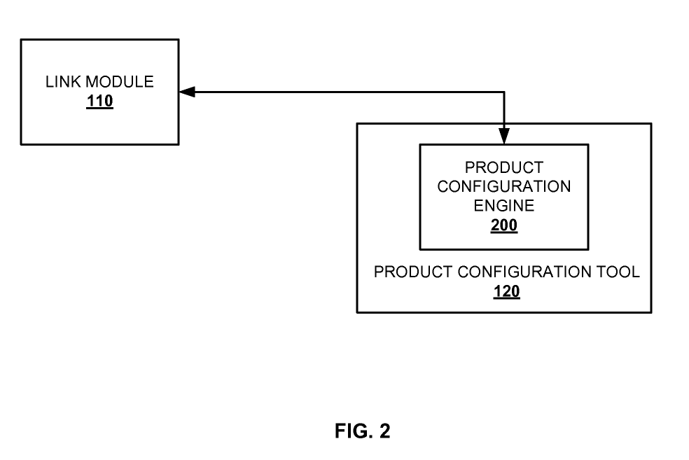

The list-of-resultant-data may be generated by a product configuration engine 200 (refer to FIG. 2). In one embodiment, the product configuration engine 200 is a part of product configuration tool 120, as illustrated in FIG. 2. In another embodiment, the product configuration tool 120 and the product configuration engine 200 are separate entities communicatively coupled to each other. The product configuration engine 200 may generate the list-of-resultant-data by searching language dependent terms and/or language independent terms in a knowledgebase (not shown) of the product configuration tool 120. The language independent texts and/or the language dependent texts may be stored as the resultant data in the list-of-resultant-data.

The resultant data may also comprise a reference (e.g., the URL/address/link) of one or more configuration tool User Interfaces (UIs) containing the corresponding terms (language dependent terms and/or the language independent terms). A configuration tool UI may be a knowledge base UI or configuration modeling UI (e.g., Product Modeling Environment for Variant Configuration (PME VC)) and/or a configuration UI. The configuration tool UI contains the one or more resultant data included in the list-of-resultant-data. In one embodiment, the product configuration engine 200 generates the list-of-resultant-data each time the user connects to the web browser (i.e., logs-in) and stores in a temporary storage medium. In another embodiment, the product configuration engine 200 generates the list-of-resultant-data once and stores in a database or a permanent storage medium.

The list-of-resultant-data may be searched by the product configuration engine 200. The product configuration engine 200 searches the list-of-resultant-data to find the one or more resultant data based upon the command received from the link module 110. The one or more resultant data are sent to the link module 110. The link module 110 displays the context menu including the one or more resultant data on the networking site 130. In one embodiment, the context menu is rendered automatically. In another embodiment, the context menu is rendered upon receiving the user's input, e.g., a depression of a key on an I/O device.

The following paragraphs describe various exemplary scenarios wherein the link module 110 renders the context menu(s) while the user writes the message (blog) on the networking site 130:

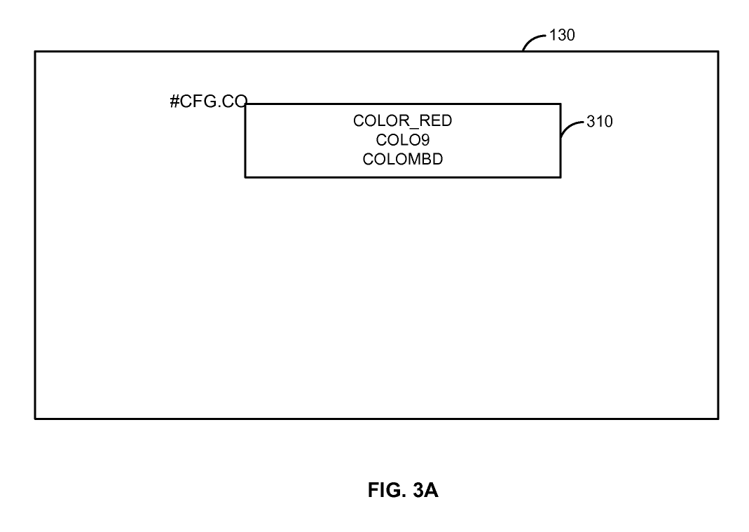

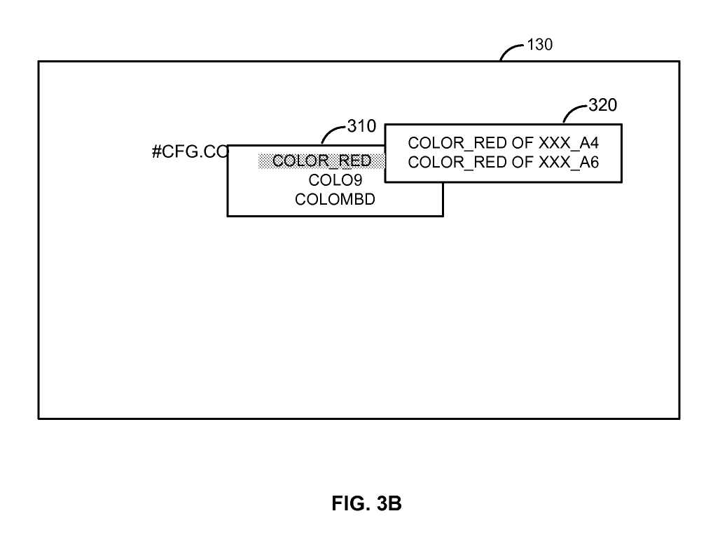

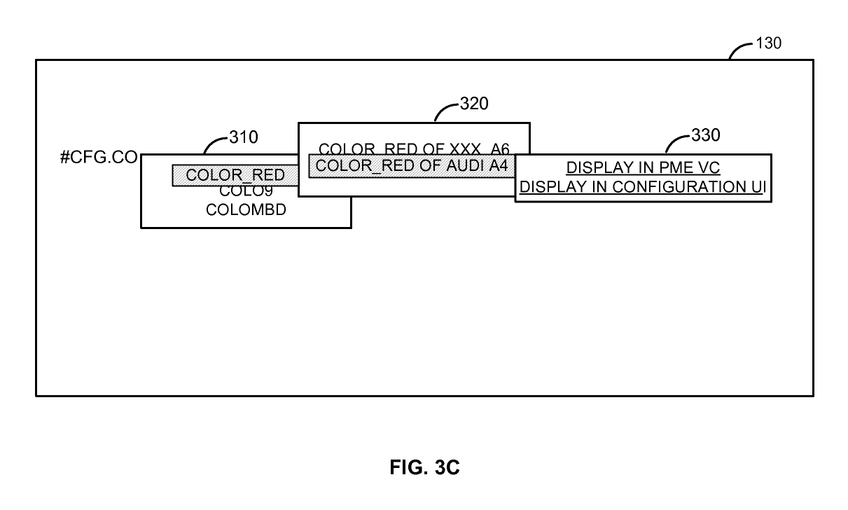

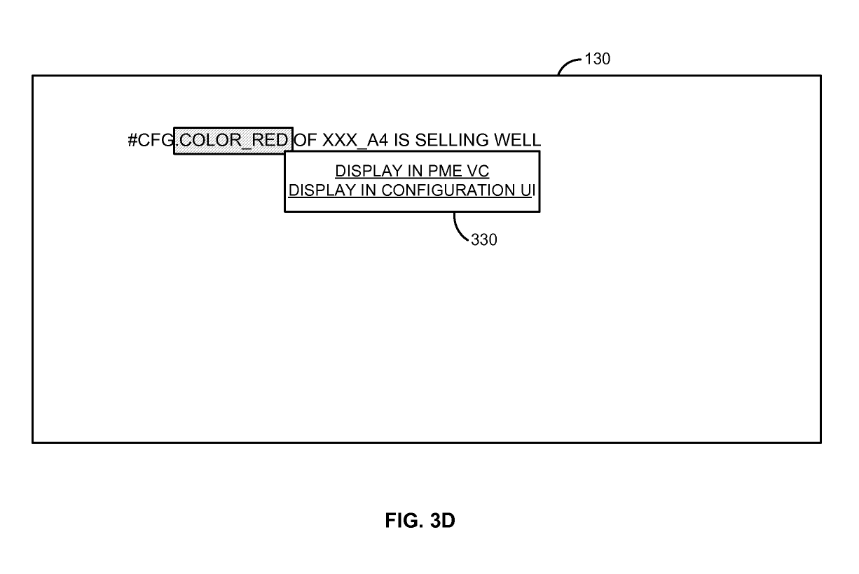

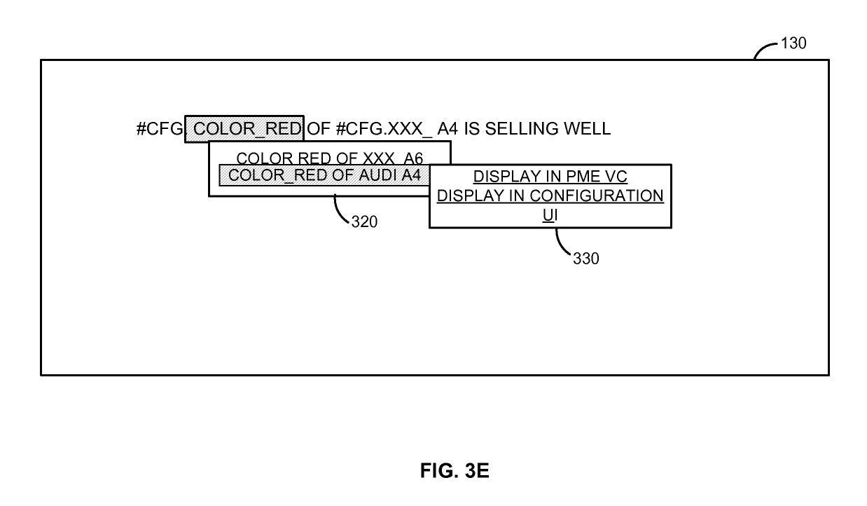

In one exemplary scenario, as illustrated in FIG. 3A, the user writes or constructs few letters of the tag, e.g., #CFG.Co. The link module 110 selects the tag under construction or Co (i.e., the active tag) and sends command including the active tag (Co) to the product configuration engine 200. The product configuration engine 200 searches the list-of-resultant-data to find one or more resultant data (completion options) for the active tag (Co). Typically, the product configuration engine 200 searches the list-of-resultant-data to find the one or more resultant data starting with letters Co. Typically, the product configuration engine 200 finds the resultant data or completion options, e.g., color red, colo9, colombd, etc., for the active tag (Co). The product configuration engine 200 sends the one or more completion options (i.e., terms starting with the letter Co) to the link module 110. The link module 110 generates a tag completion menu 310 including the one or more completion options (e.g., color_red, colo9, colombd, etc) for the active tag (Co). The user can select any one of the completion options (color_red, colo9, colombd, etc) from the tag completion menu 310. Based upon the user's selection, the active tag (i.e., Co) may get replaced by the selected completion option. For example, if the user selects color_red then the active tag (i.e., Co) gets replaced by (color_red) and the blog reads as #CFG.color_red.

In one exemplary scenario, as illustrated in FIG. 3B, the user may not select the completion option and only interacts with the completion option on the tag completion menu 310. For example, the user may place a cursor upon one of the completion options on the tag completion menu 310. If the user interacts with one of the completion options (e.g., color_red), the context selection menu 320 may be rendered. The context selection menu 320 includes one or more context options related to the interacted completion option. For example, the context selection menu 320 may display “color_red of XXX_A4” and “color_red of XXX_A6” as possible context options for the completion option “color_red.” Typically, XXX_A4 and XXX_A6 may be car models manufactured by the car manufacturer “XXX.” The user may select one of the context options. For example, the user may select “color_red of XXX_A4.” Based upon the user selection, the active tag (i.e., Co of FIG. 3B) may be replaced by the selected context option, i.e., color_red of XXX_A4. In one embodiment, the active tag (Co) may be replaced as “color_red of #CFG.XXX_A4.”

In one exemplary scenario, as illustrated in FIG. 3C, the user may not select the context option and only interacts with the context option on the context selection menu 320. For example, the user may place the cursor upon one of the context options (e.g., color_red of XXX_A4) on the context selection menu 320. If the user interacts with any one of the context options, the tool selection menu 330 may be rendered. The tool selection menu 330 may include one or more references/ links of corresponding configuration tool UI related to the interacted context option. For example, if the user interacts with the context option “color_red of XXX_A4”, the tool selection menu 330 may display the references (links) “display in PME VC” and “display in configuration UI” that contains or relates to the interacted context option, e.g., color_red of XXX_A4.

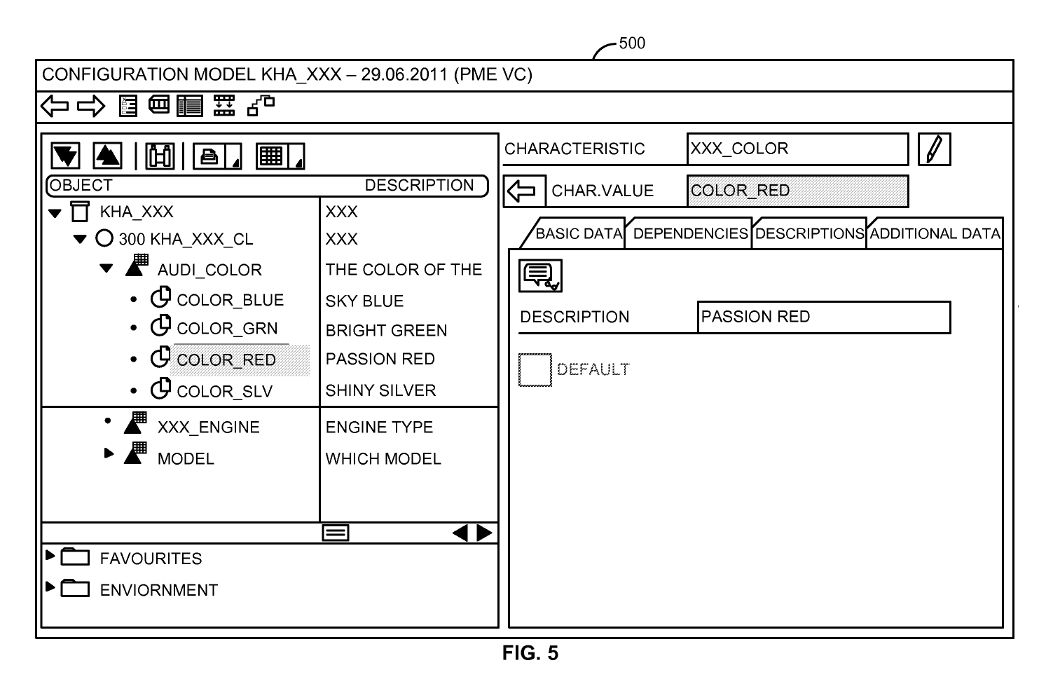

In one exemplary scenario, the user may select any one of the link from the tool selection menu 330. The link includes the reference of the configuration tool UI (e.g., configuration modeling UI). The link module 110 sends command to the configuration tool UI of the selected link to highlight the completion option (color_red) included therein. Typically, when the link is triggered, the configuration tool UI may be generated. For example, when the link is triggered, the configuration modeling UI, e.g., PME VC interface 500 (refer to FIG. 5) may be generated. The PME VC interface 500 includes the highlighted completion option (i.e., color_red). In one embodiment, the link module 110 may directly interact with the configuration tool UI. In another embodiment, the link module 110 interacts with the configuration tool UI through the product configuration engine 200.

In one exemplary scenario, as illustrated in FIGS. 3D-3E, the user may trigger or select a completed tag, e.g., color_red. The link module 110 sends the command including the selected or active tag (color_red) to the product configuration engine 200. In one embodiment, the link module 110 sends the command including either an entire blog (each term of the blog) to the product configuration engine 200 or the active tag and one or more inactive tags to the product configuration engine 200. The product configuration engine 200 determines the context of the active tag (i.e., color_red) based upon either each term of the blog and/or the one or more inactive tags. For example, if the active tag is “color_red” and the inactive tag is “XXX A4” the product configuration engine 200 may determine the context of the active tag, i.e., color_red is in context of XXX A4. The product configuration engine 200 then searches the link of the configuration tool UIs containing the active tag (i.e., color_red). The product configuration engine 200 sends the link of the configuration tool UIs containing the active tag (i.e., color_red) to the link module 110. The link module 110 renders the tool selection menu 330, as illustrated in FIG. 3D. The tool selection menu 330 includes the one or more reference/ link of the configuration tool UIs related to the active tag (color_red). For example, the link of the configuration tool UIs, e.g., “display in PME VC” and “display in configuration UI” may be displayed. If the user selects any one of the link from the tool selection menu 330, the link module 110 sends command to the configuration tool UI of the selected link to highlight the active tag (i.e., color_red) included therein. For example, if the user selects “display in PME VC”, the link module 110 sends command to the PME VC interface 500 to highlight the active tag (i.e., color_red) included therein. Typically, the configuration tool UI (e.g., PME VC interface 500) may be generated with highlighted active tag (e.g., color_red) included therein, as illustrated in FIG. 5.

In one exemplary scenario, the product configuration engine 200 may be unclear about the context of the active tag. For example, the product configuration engine 200 may be unclear about the context of the active tag even if the inactive tag(s) or the entire blog is sent to the product configuration engine 200. If the context of the active tag is unclear, the product configuration engine 200 sends the one or more context options to the link module 110. The link module 110 receives the one or more context options and displays the context selection menu 320 on the networking site 130, as illustrated in FIG. 3E. The context selection menu 320 includes the one or more context options related to the interacted or active tag. For example, the context selection menu 320 may include “color_red of XXX_A4” and “color_red of XXX_A6” as possible context options for the active tag “color_red.” The user may select one of the context options. For example, the user may select “color_red of XXX_A4.” Based upon the user selection, the active tag (i.e., Color_red of FIG. 3E) may be replaced by the selected context option, i.e., color_red of XXX_A4. In one embodiment, the active tag (Color_red) may be replaced as “color_red of #CFG.XXX_A4. In case the user only interacts with the context option, the tool selection menu 330 (refer to FIG. 3E)) may be rendered, as discussed above.

The following paragraphs describe various exemplary scenarios wherein the link module 110 renders the context menu(s) while reading the posted blog on the networking site 130:

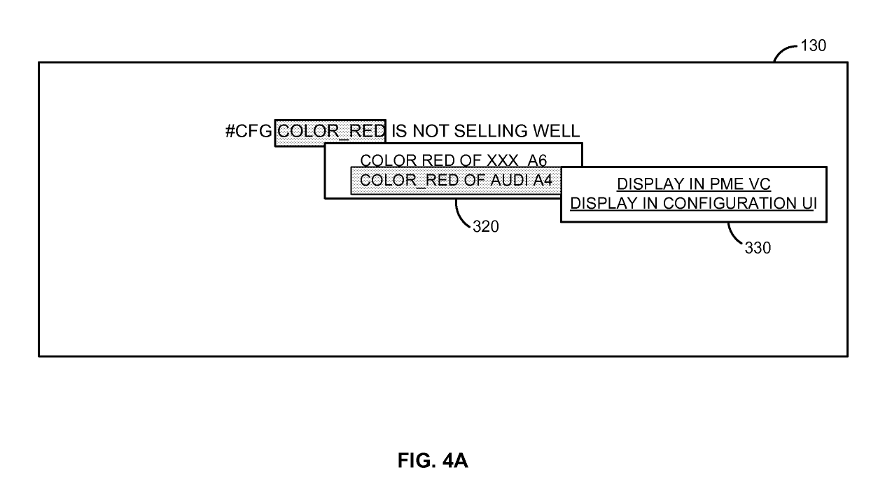

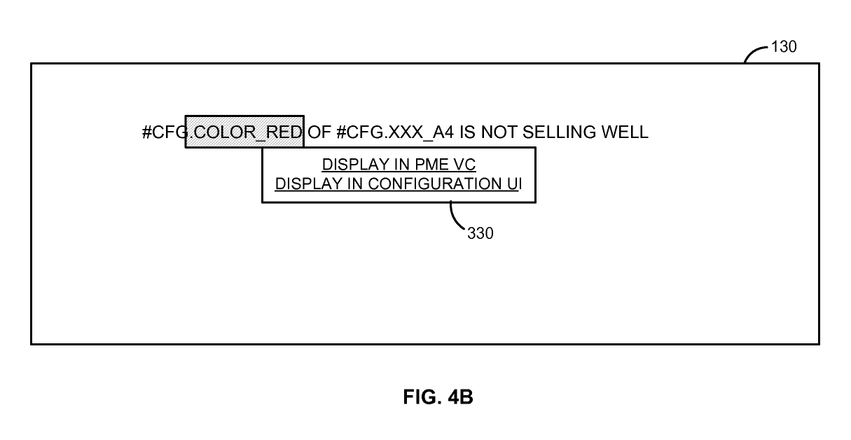

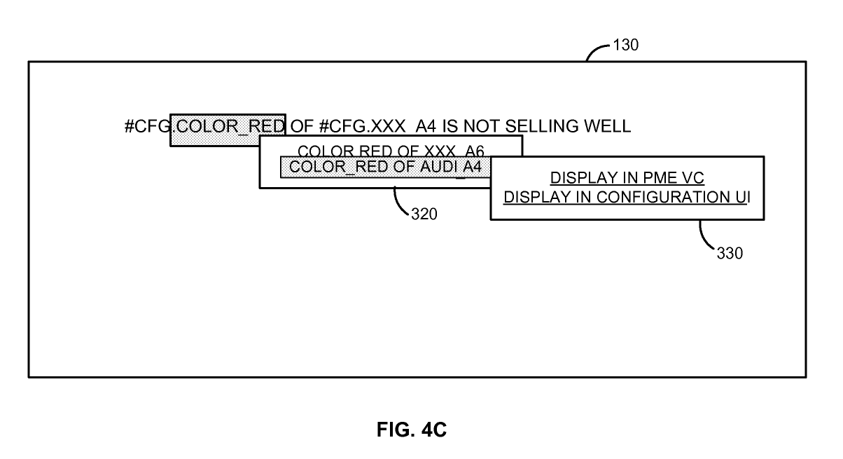

In one exemplary scenario, as illustrated in FIG. 4A, the posted blog may read “#CFG. Color_red is not selling well.” The user reading the blog (end user) may want to know in which context (XXX A4 or XXX A6) the blog is written. The end user may select or interact with the tag “color_red” to know the context of the tag (color_red). When the user selects the tag color_red, the context selection menu 320 is displayed. The context selection menu 320 includes two contexts options related to the tag “color_red” (e.g., Color_red of XXX_A4 and Color_red of XXX_A6) (refer to FIG. 4A). If the user interacts or selects any one of the context options, the tool selection menu 330 is displayed. For example, if the user places the cursor upon the context option (Color_red of XXX_A4), the tool selection menu 330 is displayed. The tool selection menu 330 includes the one or more reference/ link of the corresponding configuration tool UIs related to the context option. For example, the tool selection menu 330 may include “display in PME VC” and “display in configuration object” for the context option “color_red of XXX_A4.”

In one exemplary scenario, if the user selects any one of the link from the tool selection menu 330, the link module 110 sends command to the configuration tool UI of the selected link to highlight the active tag (i.e., color_red) included therein. For example, if “display in PME VC” is selected, the link module 110 sends command to the PME VC to highlight the active tag (i.e., color_red) included therein. Typically, the configuration tool UI (e.g., PME VC interface 500) may be generated with highlighted active tag (e.g., color_red) included therein, as discussed above.

In one exemplary scenario, as illustrated in FIG. 4B, the posted blog may read “#CFG. Color_red of #CFG.XXX_A4 is not selling well.” The user reading the blog may want to check the configuration tool UI of XXX A4 of red color. The user may select the tag “color_red” to access the configuration tool UI (knowledgebase UI or configuration UI) containing red color of XXX A4. The two cases may be possible:
Case 1: the link module 110 sends the command including the active tag and either the entire blog (each term of the blog) or one or more inactive tags (e.g., XXX_A4). The product configuration engine 200 determines the context of the active tag based upon the received each term of the blog or the inactive tag (XXX_A4). For example, the product configuration engine 200 may determine that the tag “color_red” is in the context of XXX A4. The product configuration engine 200 then directly sends the one or more links of the configuration tool UIs, containing “color_red”, to the link module 110. The link module 110 illustrates the tool selection menu 330, as illustrated in FIG. 4B. The tool selection menu 330 includes the one or more links of the configuration tool UI containing the active tag (color_red). For example, the tool selection menu 330 includes the links “display in PME VC” and “display in configuration UI” containing “color_red”. If the user selects any one of the link from the tool selection menu 330, the link module 110 sends command to the configuration tool UI of the selected link to highlight the active tag (i.e., color_red) included therein. For example, if “display in PME VC” is selected, the link module 110 sends command to the PME VC to highlight the active tag (i.e., color_red) included therein. Typically, the configuration tool UI (e.g., PME VC interface 500) may be generated with highlighted active tag (e.g., color_red) included therein, as illustrated in FIG. 5.
Case 2: The product configuration engine 200 may be unclear about the context of the active tag. The product configuration engine 200 may be unclear about the context of the active tag even if the inactive tag (XXX_A4) and/or the entire blog is sent to the product configuration engine 200. If the context is unclear, the product configuration engine 200 sends the one or more context options as the resultant data to the link module 110. The link module 110 receives the one or more context options and displays the context selection menu 320 on the networking site 130, as illustrated in FIG. 4C. The context selection menu 320 includes the one or more context options related to the active tag. For example, the context selection menu 320 may include “color_red of XXX_A4” and “color_red of XXX_A6” as possible context options for the active tag “color_red.” The user may select/ trigger one of the context options. For example, the user may select “color_red of XXX_A4.” Based upon the user selection, the tool selection menu 330 (refer to FIG. 4C) may be rendered. The tool selection menu 330 includes the one or more reference/ link of the configuration tool UIs containing the active tag (color_red). For example, the tool selection menu 330 includes the link “display in PME VC” and “display in configuration UI” containing color_red. If the user selects any one of the link from the tool selection menu 330, the link module 110 sends command to the configuration tool UI of the selected link to highlight the active tag (i.e., color_red) included therein. For example, if “display in PME VC” is selected, the link module 110 sends command to the PME VC to highlight the active tag (i.e., color_red) included therein. Typically, the configuration tool UI (e.g., PME VC interface 500) may be generated with highlighted active tag (e.g., color_red) included therein, as illustrated in FIG. 5.

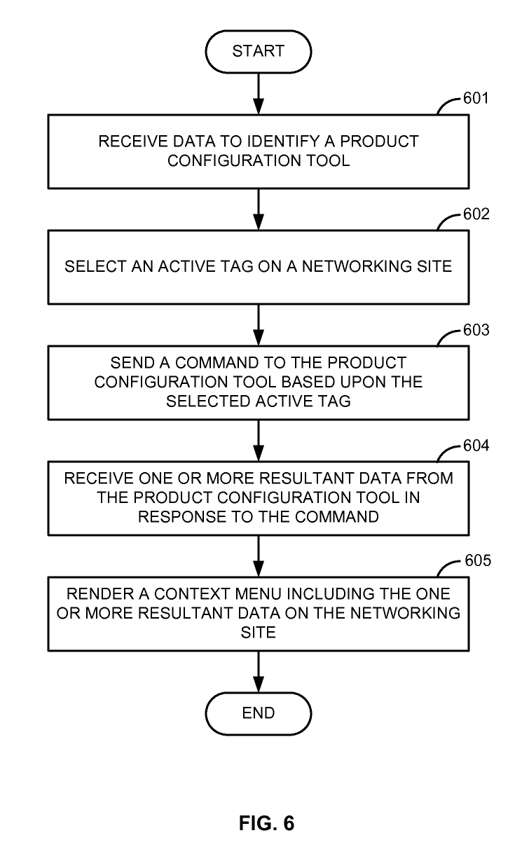

FIG. 6 is a flowchart illustrating a method for linking the product configuration tool 120 with the networking site 130 using the link module 110. Typically, the link module 110 receives the data to identify the product configuration tool 120 at step 601. Once the product configuration tool 120 is identified, the link module 110 links the identified product configuration tool 120 with the networking site 130. Basically, the link module 110 selects the active tag on the networking site 130 at step 602. Based upon the selected active tag, the link module 110 sends command to the product configuration tool 120 at step 603. The command includes the active tag and/or the data related to the active tag. The product configuration tool 120 receives the command and sends response to the link module 110. The response comprises the one or more resultant data related to the active tag. For example, the response may comprise the one or more completion options for the active tag that is under construction. Typically, the product configuration engine 200 searches the one or more resultant data related to the active tag from the list-of-resultant-data. The one or more resultant data is sent to the link module 110. The link module 110 receives the response including the one or more resultant data from the product configuration engine 200 at step 604. The link module 110 renders the context menu including the one or more resultant data on the networking site 130 at step 605.

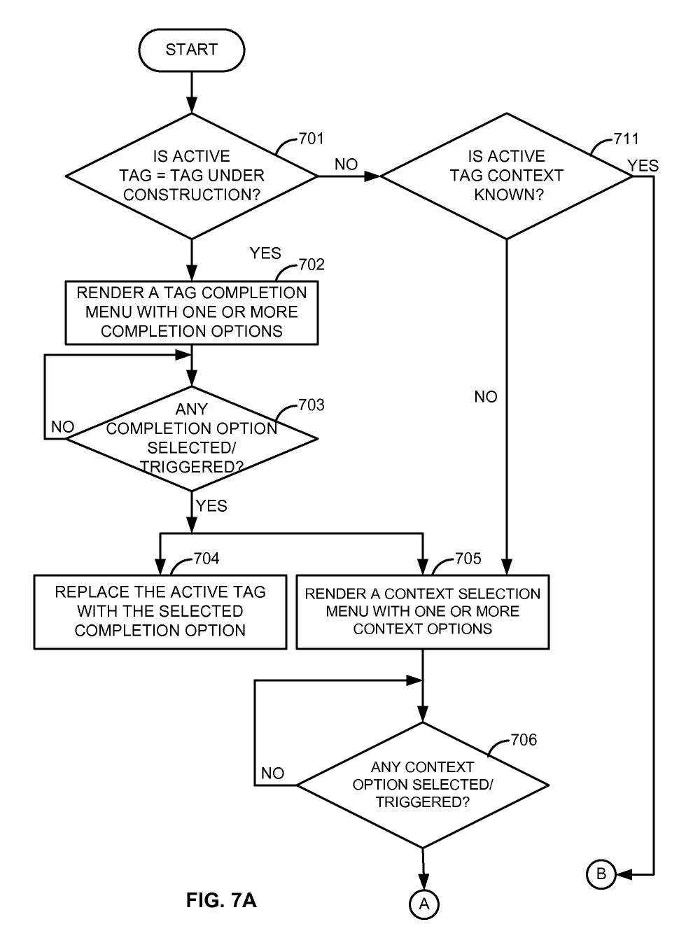

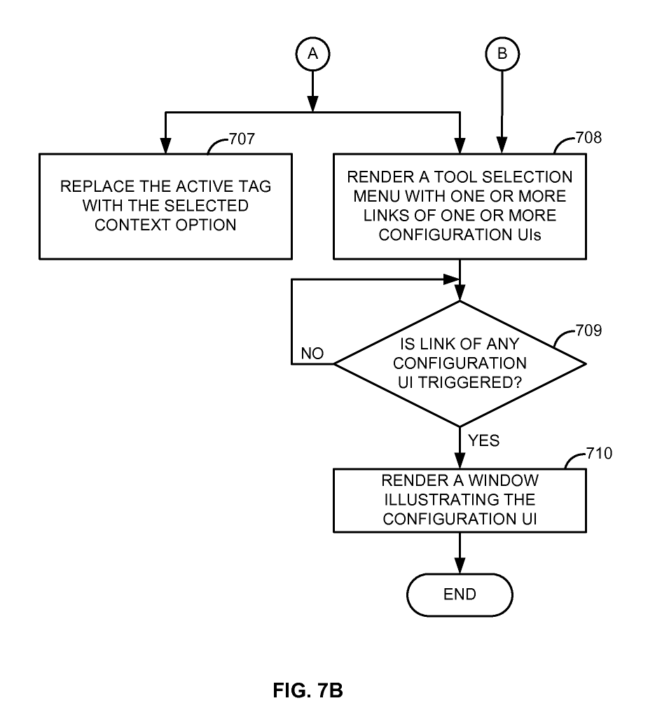

FIGS. 7A-7B is a flowchart illustrating a method for rendering various context menus while writing and/or reading the blog. Typically, the link module 110 detects the active tag on the networking site 130. The active tag may be the tag under construction. If the active tag is the tag under construction (step 701: YES), the link module 110 sends command including the tag under construction to the product configuration engine 200. The product configuration engine 200 searches the list-of-resultant-data and retrieve the one or more completion options (resultant data) starting with the letters of the tag under construction. For example, if the tag under construction starts with “Co”, the product configuration engine 200 searches the list-of-resultant-data to retrieve the resultant data starting with the letter “Co”. The product configuration engine 200 sends the one or more completion options (resultant data starting with the letter Co) to the link module 110. The link module 110 renders the tag completion menu 310 including the one or more completion options at step 702. If the user selects any one of the completion option from the tag completion menu 310 (step 703: YES), then the active tag (tag under construction) gets replaced by the selected completion option at step 704. In case the user does not select any of the completion option but only interacts with the completion option of the tag completion menu 310, the context selection menu 320 is generated at step 705. The context selection menu 320 includes the one or more context related to the triggered completion option. If the user selects any of the context option (step 706: YES) then the active tag (tag under construction) is replaced by the selected context option at step 707. For example, the user may select “color_red of XXX_A4” from the context selection menu 320. Based upon the user selection, the active tag (tag under construction) may be replaced by the selected context option, i.e., color_red of XXX_A4. In one embodiment, the active tag may be replaced as “color_red of #CFG.XXX_A4.” In case the context option is not selected but only interacted, the tool selection menu 330 is generated at step 708. The tool selection menu 330 includes the links of the one or more configuration tool UIs. In case the user triggers or selects any of the link (step 709: YES), the new window illustrating the configuration tool UI of the selected or triggered link is rendered at step 710. The configuration tool UI includes the highlighted completion option.

In case the active tag is not the tag under construction (step 701: NO), the link module 110 sends the command including at least one of the active tag and either the entire blog or one or more inactive tags to the product configuration tool engine 200. Based upon the command, the product configuration engine 200 may determine the context of the active tag. If the context of the active tag is not determined (step 711: NO), the product configuration engine 200 sends the one or more context options related to the active tag. The link module 110 receives the one or more context options. The link module 110 renders the context selection menu 320 including the one or more context options at step 705. Steps 706-710 may be followed or repeated, as discussed above.

In case the context of the active tag is determined by the product configuration engine 200 (step 711: YES), the product configuration engine 200 directly sends the one or more reference or link of the configuration tool UIs containing the active tag. The link module 110 renders the tool selection menu 330 including the one or more links of the configuration tool UI at step 708. Steps 709-710 may be followed or repeated, as discussed above.

The embodiments of the invention enable to link the networking site(s) with one or more product configuration tool or vice versa. Essentially, the linking of social networking site(s) with the product configuration tool enables the sales representatives to communicate effectively and efficiently. Importantly, the user or the sales representatives can easily refer to or access the product configuration tool while composing or reading the blog(s) on the social networking site(s). Additionally, the user can also refer to the context related to the unknown business terms (the active tag). Moreover, the user can access configuration UIs for maintaining knowledge base and/or visualizing a configuration of the product configuration tool from the networking site(s).

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

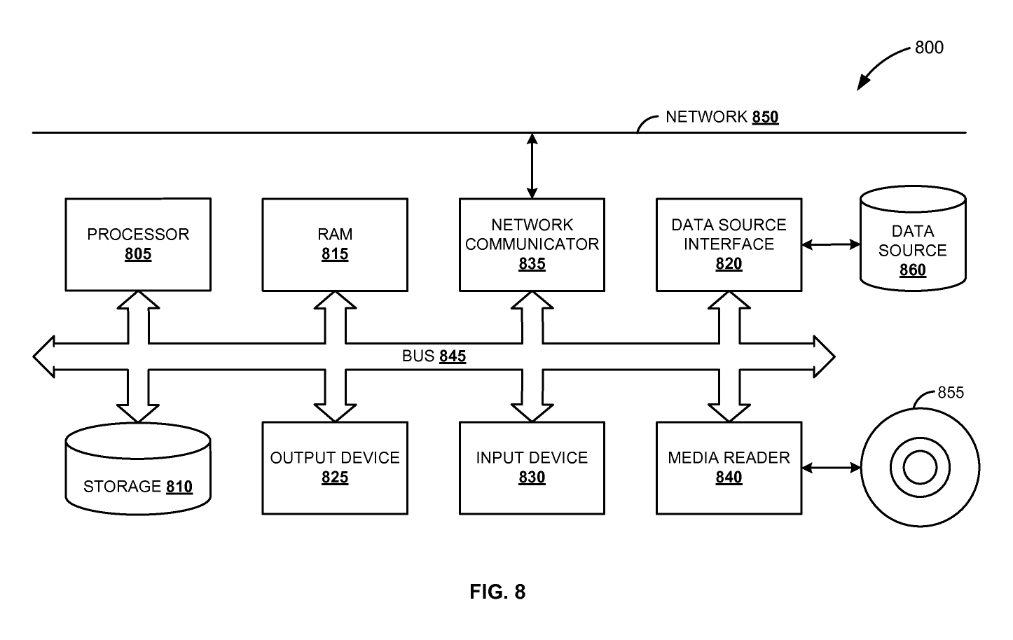

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
select an active tag on a networking site, wherein the active tag is prefixed by an identifier;
based upon the active tag, send a command to a product configuration tool;
in response to the command, receive one or more resultant data related to the active tag; and
render a context menu including the one or more resultant data on the networking site.

2. The article of manufacture of claim 1, wherein the identifier comprises at least one of alphanumeric characters and symbols and wherein selecting the active tag comprises identifying the identifier prefixed to the active tag.

3. The article of manufacture of claim 1, wherein the active tag comprises a tag in interaction with a user.

4. The article of manufacture of claim 1, wherein the context menu is rendered upon receiving a user input or automatically.

5. The article of manufacture of claim 1, wherein the context menu is a tag completion menu and the one or more resultant data is one or more completion options.

6. The article of manufacture of claim 5 further comprising instructions which when executed cause the computer to:
receive a user selection of a completion option from the one or more completion options; and
based upon the user's selection, replace the active tag with the selected completion option.

7. The article of manufacture of claim 5 further comprising instructions which when executed cause the computer to:
render a context selection menu upon receiving a user input, wherein the context selection menu includes one or more context options related to the completion option.

8. The article of manufacture of claim 7 further comprising instructions which when executed cause the computer to:
receive a user selection of a context option; and
based upon the user's selection, replace the active tag with the selected context option.

9. The article of manufacture of claim 7 further comprising instructions which when executed cause the computer to:
render a tool selection menu upon receiving a user input, wherein the tool selection menu includes one or more links of corresponding one or more configuration tool User Interfaces (UIs) related to a context option;
determine if a link of a configuration tool UI is triggered; and
if the link of the configuration tool UI is triggered, perform the following:
send an instruction to the configuration tool UI to highlight at least one of the active tag and the completion option included therein; and
display the configuration tool UI including at least one of the highlighted active tag and the highlighted completion option.

10. The article of manufacture of claim 1, wherein the context menu is a context selection menu and the one or more resultant data is one or more context options.

11. The article of manufacture of claim 10 further comprising instructions which when executed cause the computer to:
receive a user selection of a context option; and
based upon the user's selection, replace the active tag with the selected context option.

12. The article of manufacture of claim 10 further comprising instructions which when executed cause the computer to:
render a tool selection menu upon interaction with a context option of the context selection menu, wherein the tool selection menu includes one or more links of corresponding one or more configuration tool User Interfaces (UIs) related to the context option;
determine if a link of a configuration tool UI is triggered; and
if the link of the configuration tool UI is triggered, perform the following:
send an instruction to the configuration tool UI to highlight at least one of the active tag and the completion option included therein; and
display the configuration tool UI including at least one of the highlighted active tag and the highlighted completion option.

13. The article of manufacture of claim 1, further comprising instructions which when executed cause the computer to:
select one or more inactive tags on the networking site, wherein the inactive tag is prefixed by the identifier and selecting the inactive tag comprises identifying the identifier prefixed to the inactive tag and wherein the command sent to the product configuration tool includes the one or more inactive tags.

14. The article of manufacture of claim 13, wherein the context menu is a tool selection menu and the one or more resultant data is one or more links of corresponding one or more configuration tool UI containing the active tag and wherein if a link of a configuration tool UI is triggered, the active tag included within the configuration tool UI is highlighted and the configuration tool UI is displayed including the highlighted active tag.

15. A method for linking a product configuration tool and a networking site, the method comprising:
receiving a data to identify the product configuration tool to be linked to the networking site;
on the networking site, selecting an active tag;
based upon the active tag, sending a command to the identified product configuration tool;
in response to the command, receiving one or more resultant data related to the active tag; and
rendering a context menu including the one or more resultant data on the networking site.

16. The method of claim 15 further comprising:
receiving a user selection of a resultant data from the one or more resultant data; and
based upon the user's selection, replacing the active tag with the selected resultant data, wherein the context menu is a tag completion menu and the one or more resultant data is one or more completion options .

17. The method of claim 15 further comprising:
rendering a context selection menu upon interaction with a resultant data, wherein the context selection menu includes one or more context options related to the resultant data;
determining if a context option is triggered;
if the context option is triggered, perform one of the following:
replacing the active tag with the triggered context option; and
rendering a tool selection menu including one or more links of corresponding one or more configuration tool UIs related to the triggered context option, wherein if a link of a configuration tool UI is triggered, perform the following:
send an instruction to the configuration tool UI to highlight at least one of the active tag and the resultant data included therein; and
display the configuration tool UI including at least one of the highlighted active tag and the highlighted resultant data.

18. The method of claim 15, wherein the context menu is a context selection menu and the one or more resultant data is one or more context options and wherein if a context option is triggered either replace the active tag with the triggered context option or perform the following:
render a tool selection menu including one or more links of corresponding one or more configuration tool UIs related to the context option; and
determine if a link of a configuration tool UI is triggered, wherein if the link of the configuration tool UI is triggered perform the following:
send an instruction to the configuration tool UI to highlight the active tag included therein; and
display the configuration tool UI including the highlighted active tag.

19. The method of claim 15 further comprising:
selecting one or more inactive tags on the networking site, wherein the inactive tag is prefixed by the identifier and selecting the inactive tag comprises identifying the identifier prefixed to the inactive tag; and
sending the one or more inactive tags along with the command.

20. The method of claim 19, wherein the context menu is a tool selection menu and the one or more resultant data is one or more links of corresponding one or more configuration tool UIs containing the active tag and wherein if a link of a configuration tool UI is triggered, perform the following:
send an instruction to the configuration tool UI to highlight the active tag included therein; and
display the configuration tool UI including the highlighted active tag.

21. A computer system for linking a product configuration tool with a networking site, comprising:
a memory to store program code;
a processor communicatively coupled to the memory, the processor configured to execute the program code to:
receive a data to identify the product configuration tool;
select an active tag on the networking site;
based upon the active tag, send a command to the identified product configuration tool;
in response to the command, receive one or more resultant data related to the active tag; and
render a context menu including the one or more resultant data on the networking site; and
a configuration tool engine communicatively coupled to the processor, the configuration tool engine operable to:
search at least one of one or more language dependent texts and one or more language independent texts from a knowledge base of the product configuration tool;
store at least one of the following as the resultant data in a list-of-resultant-data:
the one or more language dependent texts;
the one or more language independent texts; and
one or more references of one or more configuration UIs containing the corresponding one or more language dependent texts and the corresponding the one or more language independent texts;
receive the command from the link module;
based upon the command, search the one or more resultant data related to the active tag; and
send the one or more resultant data related to the active tag to the processor.
